(19) United States
(12) Patent Application Publication
(10) Pub. No.: US 2012/0105949 A1
(43) Pub. Date: May 3, 2012

(54) Additive Manufacturing-Based Compact Epifluorescence Microscope

(76) Inventors: Eric B Cummings, Livermore, CA (US); Kirsten K Pace, Livermore, CA (US); Roger A Philpott, Livermore, CA (US)

(21) Appl. No.: 12/938,287

(22) Filed: Nov. 2, 2010

(51) Int. Cl. G02B 21/06; G02B 21/00

(52) U.S. Cl. 359/385; 359/368

(57) ABSTRACT

An epifluorescence microscope achieves a compact form factor without sacrificing optical sensitivity by the novel use of combined optic mounts and light baffles constructed using additive manufacturing processes. The use of additive manufacturing enables stray-light-capturing structures that are not practical to make by other techniques. Some embodiments of the present invention do not require installation of filters by an operator, reducing the likelihood of dust and contamination on optical surfaces. Some embodiments of the present invention employ a novel light path that avoids passing the fluorescent light through off-axis elements. This optical arrangement provides for the use of a microscope objective having a finite corrected-image distance, such as a DIN objective, rather than infinity-corrected objective that require additional optical elements to form an image. The reduction in complexity can both reduce system cost and improve optical performance by reducing Fresnel losses and imaging artifacts from Fresnel reflections.

### BACKGROUND OF THE INVENTION

Fluorescence microscopy is an essential tool in microbiology and medicine. In fluorescence, light of one wavelength is absorbed by molecules and re-emitted at a different wavelength. The absorption and emission wavelengths depend on the specific molecules. The separation in wavelengths between absorption and emission allows the background of non-fluorescent light to be filtered from the fluorescence signal, enhancing the sensitivity and providing for quantitative image analysis. In epifluorescence microscopy, the excitation light passes to the sample through the microscope objective that captures the fluorescent light, requiring access to one side of a sample only and allowing fluorescence microscopy on non-transparent objects. An assembly of precision filters and beam-splitters is typically used in epifluorescence. These elements are often conventionally mounted in an interchangeable filter cube that is inserted into a suitably designed microscope by the microscope operator.

Unfortunately, the filter cubes and microscopes are expensive objects. Operators may introduce dust, which can affect image quality, while changing out filter sets. Moreover, the conventional optical arrangement in epifluorescence microscopes passes the fluorescence through an inclined beamsplitter, with adverse effects on the microscope image.

### SUMMARY OF THE INVENTION

The object of the present invention is to create an epifluorescence microscope that does not suffer from these conventional drawbacks. Embodiments of the present invention achieve a compact form factor without sacrificing optical sensitivity by the novel use of combined optic mounts and light baffles constructed using additive manufacturing processes. The use of additive manufacturing enables stray-light-capturing structures that are not practical to make by other techniques. The compact form of the microscope reduces cost, weight, and improves stiffness with no reduction in optical performance over larger conventional microscopes. Some embodiments of the present invention do not require installation of filters by an operator, reducing the likelihood of dust and contamination on optical surfaces. Some embodiments of the present invention employ a novel light path that avoids passing the fluorescent light through off-axis elements. This optical arrangement provides for the use of a microscope objective having a finite corrected-image distance, such as a DIN objective, rather than infinity-corrected objective that require additional optical elements to form an image. The reduction in complexity can both reduce system cost and improve optical performance by reducing Fresnel losses and imaging artifacts from Fresnel reflections.

### BRIEF DESCRIPTION OF THE DRAWINGS

FIG. 1 illustrates an epifluorescence microscope according to the present invention;

FIG. 2A shows a top isometric view of the epifluorescence microscope of FIG. 1;

FIG. 2B is a side view of the epifluorescence microscope according to the present invention;

FIG. 3 is a side view of an optical path through an epifluorescence microscope according to an embodiment of the present invention;

FIG. 4A shows a hatched center-section side view of an epifluorescence microscope according to the present invention;

FIG. 4B shows a cross sectional view of an epifluorescence microscope according to the present invention;

FIG. 5A shows a top isometric view of the body of an epifluorescence microscope according to the present invention;

FIG. 5B shows a bottom isometric view of the body an epifluorescence microscope according to the present invention;

FIG. 5C shows a top isometric view of a section of the body split down the center, revealing the inner features;

FIG. 6A is a top isometric view of the illuminator housing;

FIG. 6B is a bottom isometric view of the illuminator housing; and

FIG. 6C is a cross sectional view of the illuminator housing.

### DETAILED DESCRIPTION OF THE INVENTION

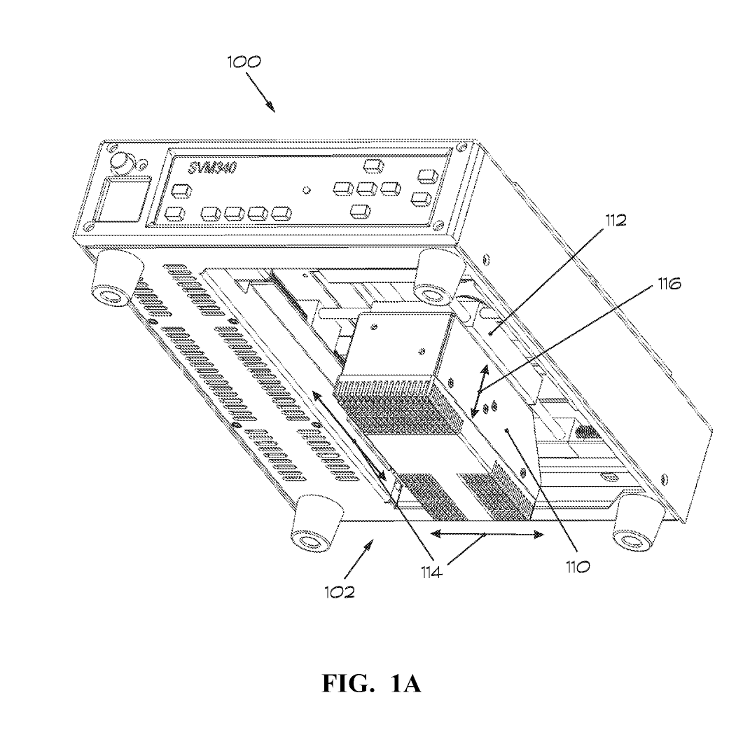

FIG. 1A shows a bottom perspective view of a video microscopy system 100 containing an epifluorescence microscope 102 according to an embodiment of the present invention. The video microscopy system is disclosed in U.S. patent application Ser. No. 11/526,158, which was published as U.S. Patent Publication 2007-0081078 A1 on Apr. 12, 2007 and which is incorporated herein by reference. In this embodiment, a motorized traverse 112 provides panning motion 114 and focus motion 116. FIG. 1B shows a top perspective view of the microscopy system.

FIGS. 1A and 1B show the epifluorescence microscope 102 according to an embodiment of the present invention in a motorized traverse. A housing 110 houses the entire epifluorescence optical train, camera, illuminator, and illuminator-strobing electronics such that the output of the microscope 102 is an electronic signal that conveys the epifluorescence image. In some embodiments, the image output in an analog format. In other embodiments, the image output is in a digital format.

As used herein an “additive manufacturing process” comprises any processes in which solid components are produced by a process of adhering, bonding, welding, soldering, brazing, sintering, polymerizing, chemically reacting, photolitically forming or otherwise linking precursor materials such as chemicals, polymers, metals, alloys, powders, beads, grains, micelles, liposomes, emulsions, epoxies, thermosets, thermoplastics, mixtures, aggregates, etc.

Examples of additive manufacturing processes include but are not limited to:

Stereolithography (SLA or SL), which generally may employ photopolymer materials;

Fused Deposition Modeling (FDM), which generally may employ thermoplastics, eutectic metals, etc.;

Selective Laser Sintering (SLS), which generally may employ thermoplastics, metal powders, etc.;

Laminated Object Manufacturing (LOM), which generally uses paper and like materials;

3D Printing (3DP), which uses a range of materials; and

Polyjet Technology, a combination of SLA and FDM, which generally employs photopolymer materials.

In the present invention, at least one element of microscope 102 is manufactured using an additive process. Some embodiments employ a black rigid polyjet-produced material. In some embodiments, the material name is “VeroBlack,” having a hardness of 82 Shore D.

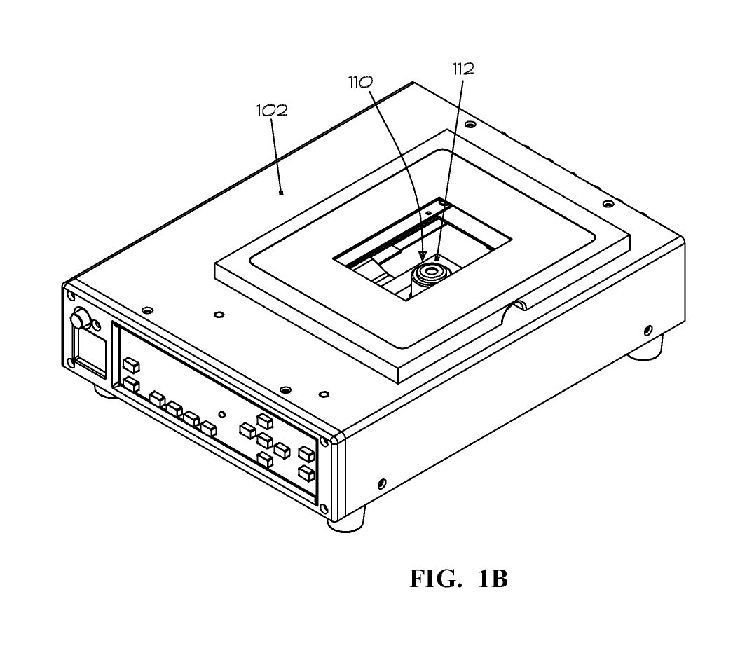

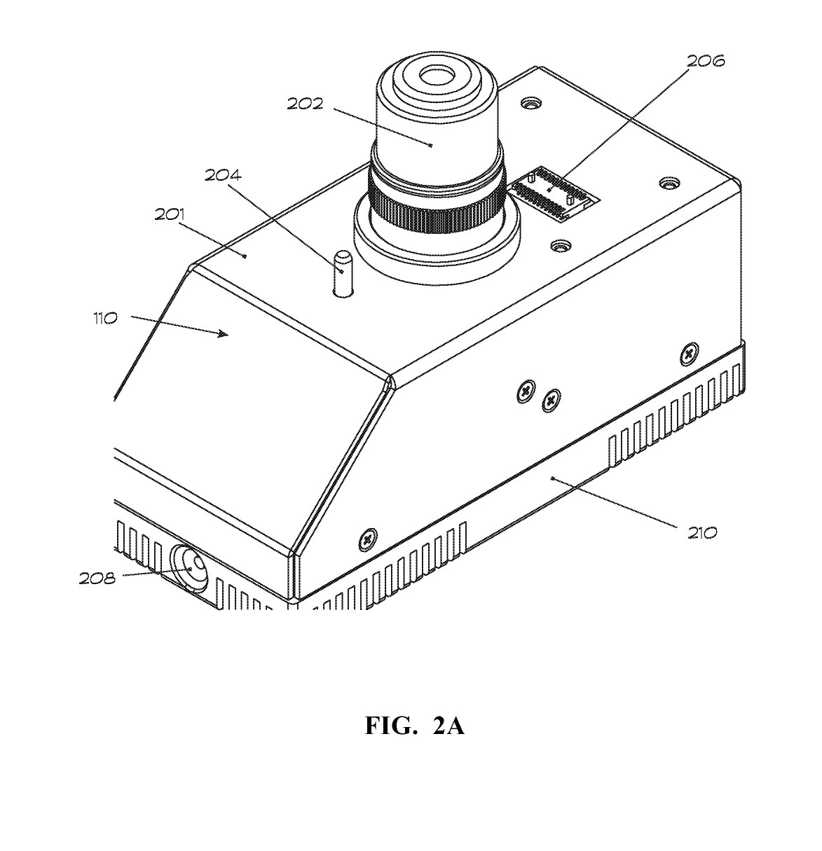

FIGS. 2A and 2B show basic external features of the epifluorescence microscope 100 according to the present invention.

FIG. 2A shows a top isometric view of a housing 110 that may be included in the epifluorescence microscope system 100. The housing includes a microscope cover 201 that may be cut, folded, and welded from sheet metal, drawn by via progressive dies, injection molded, die cast, cast-in-place, or otherwise manufactured. In some embodiments, this cover 201 provides stiffening, light-proofing, and liquid spill resistance. In some embodiments the microscope cover 201 and a base 210 are permanently sealed against dust. In some embodiments the seal is light and dust tight. In some embodiments the seal is liquid tight. In some embodiments the seal is not air tight to all equalization of pressures or a dust-proof vent is included.

In some embodiments cover 201 supports other elements, such as a microscope objective lens 202, one or more alignment and centering features, such as a post 204, and an electronic interface 206. In some embodiments, the electronic interface 206 carries circuits including power and signaling.

Power circuits may include power for logic, power for the illuminator, power for the camera, etc. In some embodiments, power is converted internally from one voltage to another within the microscope to support the requirements of different electronic devices.

In some embodiments signaling circuits may include digital communications lines, triggering or control lines, video signaling lines, etc. Digital communications may employ differential signaling, e.g., RS485 and the like, I2C, SPI standard communications, USB-1, USB-2, USB-3, Ethernet, IEEE1394, or other standards or custom signaling schemes known in the art.

In some embodiments, triggering or control lines may be used to control strobing of the illuminator and to transmit real-time triggering information to or from the microscope camera.

In some embodiments one or more electronic circuits may employ a connector 208 situated elsewhere, of example at an end of the housing 110. In some embodiments, a connector may provide power. In some embodiments a connector may conform to USB, Ethernet, or IEEE1394 physical and signaling standards. In some embodiments, a custom connector may be employed. Some embodiments may power the microscope in part or full by power from a bus, e.g., USB, IEEE1394, power over Ethernet, and the like.

In other embodiments, at least one electronic circuit is made wirelessly, e.g., via radio techniques, inductive coupling, capacitive coupling, etc. Some preferred embodiments expose a reduced number of or no conductors to the exterior of the microscope, potentially providing a maximum protection against damage from spills. In some embodiments, the microscope transmits video information wirelessly. In some embodiments, the microscope control signals are transmitted wirelessly. In some embodiments, the microscope contains a power source, e.g., a battery, ultracapacitor, and the like.

Some embodiments of the present invention contain a heat sink/cooling plate in the base 210.

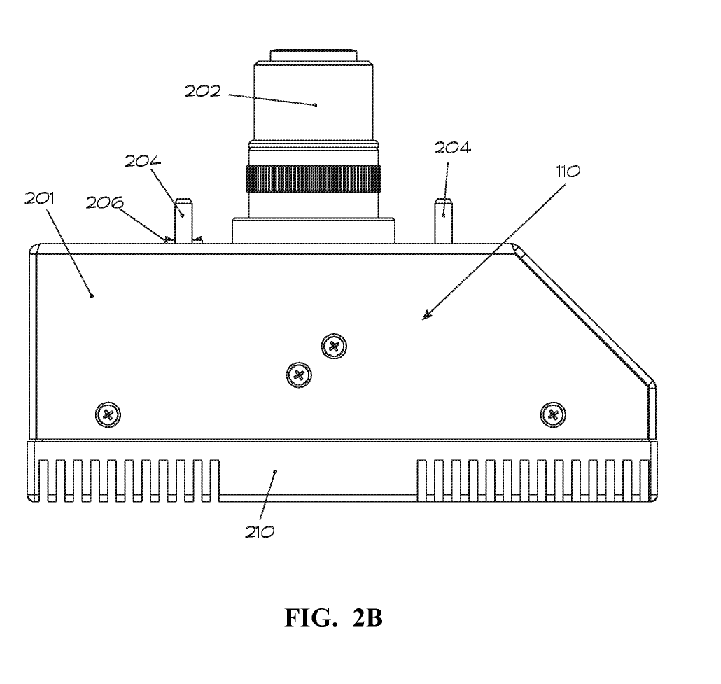

FIG. 3 is a side view of the optical path 300 through epifluorescence microscope system 100 according to an embodiment of the present invention. A light source 302, e.g., a power light-emitting diode (LED), laser, flashlamp, arc lamp, gas-discharge lamp, or the like provides illumination for the epifluorescence microscope 102.

If the light source 302 has a narrow spectral bandwidth like an LED or laser, the light source 302 may comprise a plurality of individually controllable emitters having different spectral outputs to provide for tuning of the excitation wavelength. The design of such a compound emitter may be complicated by the need not to produce a marked shift in the illumination pattern when switching sources. Spatial interleaving or optical interleaving of emitter elements may be employed to produce a spatially stable illumination pattern.

Light from the light source 302 passes through a first condenser optic 304 and a second condenser optic 306 that are shown as being lenses. Some alternative embodiments of the condenser optics may employ reflective, diffractive, Fresnel, holographic optics and the like to direct illuminator light efficiently along the ray path 301 instead of refractive condenser lenses. An aperture 308 prevents stray rays from the light source 302 from entering the microscope or impinging on an excitation filter 310 at a significant angle, which may be important for maintaining a sharp pass-band cut-off if filter 310 is an interference filter. Excitation filter 310 removes components of the spectrum emitted by the illuminator 302 that overlap the fluorescence signal spectrum substantially. This filter 310 may be a colored glass or molecular filter. However, in preferred embodiments, this filter may be an interference filter or a combination of molecular absorption and interference filter because of the enhanced control over cut-off frequency and reduced autofluorescence provided by an interference filter. Filter autofluorescence may generate a false background signal and limit the sensitivity of the microscope.

In some preferred embodiments, the illumination wavelength may be adjusted by changing elements 302, 310, or a combination. If the illuminator 302 has a broad spectral output, it may be preferable to change the excitation filter 310 characteristics. This may be accomplished by the use of an excitation filter having a spatially varying passband and physically displacing the filter, angle-tuning the excitation filter by tilting it more or less with respect to the ray path 301, arranging a plurality of filters having different passbands in a selectable fixture, the use of an electrically tunable filter such as an acousto-optic module, etc. In some embodiments, particularly when the illuminator has a narrow spectral emission, a plurality of illuminator elements, e.g., 302 and 310, or 302, 304, 306, 308, and 310 may be changed in a group.

In some embodiments, these adjustments or changes may be manual. In some embodiments, these changes may involve removing and replacing elements in the system. In such embodiments, care should be exercised in the design to avoid the introduction of dust to the microscope, at least in locations where it produces a visible defect in the microscope image. In preferred embodiments these adjustments or changes may be mechanized, e.g., via a DC motor, solenoid, brushless DC motor, stepper motor, and the like.

The illuminator rays substantially follow path 301 to a beamsplitter 312. In some preferred embodiments, this beamsplitter has a dichroic characteristic: passing the illumination or excitation wavelength selectively and reflecting the fluorescence or emission wavelength selectively. In other embodiments, this beamsplitter may have a substantially neutral spectral response and an approximately 50% reflectivity. Such an embodiment may be favorable for supporting multiple excitation and emission wavelengths without the need to change the beamsplitter. The advantage of using a dichroic beamsplitter is significantly greater fluorescence signal strength and a reduction in bleed through of the excitation light on the camera image.

Beamsplitter 312 has the unfortunate consequence of producing a stray reflection of the illuminator rays along path 311. Surfaces that these stray rays land on are in the field of view of the camera and require careful attention to avoid contamination of the fluorescence image.

A fraction of excitation rays pass through the beamsplitter 312 and follow path 313 through the objective lens set 202 and onto sample 314. A component of the fluorescence produced by those rays passes back through the objective lens set substantially along path 315. When these rays reach the top surface 316 of beamsplitter 312, a significant part of the rays reflect substantially along path 317. Because these rays are reflected by the top surface of the beamsplitter, the beamsplitter produces no image aberrations.

This lack of aberrations is an important improvement over conventional epifluorescence microscopes in which the fluorescence rays pass through the tilted beam splitter on their way to forming an image, which might introduce aberrations, particularly for non-infinity corrected objectives.

The rays 317 reflect off a folding mirror 318 into rays 319, and then reflect off mirror 320 into rays 321. The purpose of the mirrors 318 and 320 is to keep the microscope body size compact. In some alternative embodiments, more, fewer, or no folding mirrors are used. The rays 321 pass through an emission filter 322 that provides a sharp cut off to block excitation wavelengths from passing while efficiently passing emission, or fluorescence, wavelengths.

In some embodiments, filter 322 can be changed or adjusted to provide good sensitivity for different fluorophores. In some embodiments, the filter 322 is adjusted or changed in a manner analogous to 310. However, angle tuning and acousto-optical filtering of the fluorescence may produce image aberrations. In some embodiments, adjustments or changeouts of 310 and 322 are ganged. In some embodiments, adjustments or changeouts of 310, 312, and 322 are ganged. In some embodiments, filter changeouts or adjustments are ganged with changes in 302.

Element 324 is a camera. In some embodiments the camera is monochromatic. In other embodiments, the camera has additional filters for color separation.

In some embodiments, the camera employs a charge-coupled device sensor. In other embodiments, the camera employs a CMOS sensor. In some embodiments, the camera has avalanche signal amplification, e.g., an electron-multiplied CCD. Some embodiments employ multi-channel plates for photon amplification.

In the embodiment in FIG. 3, the optical path length through the microscope is fixed at 160 mm, in accordance with the DIN standard. Focus and panning is adjusted by moving the entire assembly with respect to the sample. In some alternative embodiments, at least some of the focus and panning is accomplished by changing the optical path through the microscope, e.g., modestly changing the path length to effect a focus or modestly tilting mirrors or beamsplitters to effect panning etc. These adjustments may be mechanized. In some embodiments, these adjustments are used to enhance depth resolution, enhance spatial resolution, remove imaging defects, enhance signal-to-noise, enhance edges, effect auto-focusing, track motion, automate acquisition over a range of depths, and a variety of other functions. An advantage of the use of internal microscope actuators over full-microscope motion may be radically reduced inertia, radically higher-frequency scanning. Actuators may include piezoelectrics, solenoids, and motors among others known in the art.

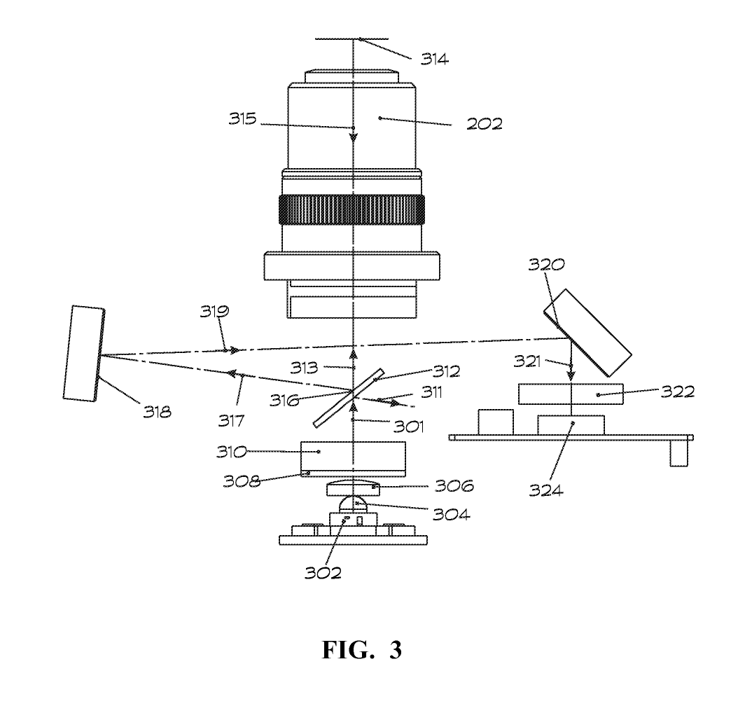

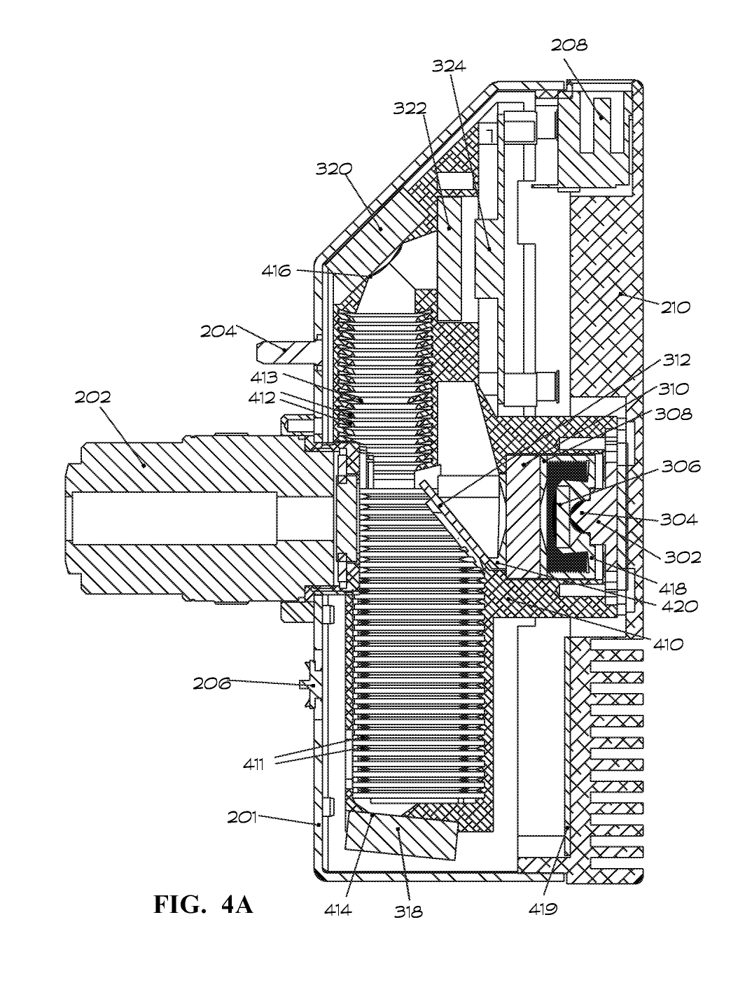

FIGS. 4A and 4B show a hatched center-section side view of an epifluorescence microscope according to the present invention. FIG. 4A shows a body 410 that is manufactured by an additive process. The surface and possibly bulk of this body is a black material such that light that contacts its surface is significantly absorbed, e.g., >70% and preferably >85%. The body 410 is designed so that stray light typically makes many reflections and passes through filters before potentially landing on the camera. In some embodiments the surface is glossy, reducing the quantity of diffusely scattered light. In some embodiments, the surface has a matte or flat sheen. In some embodiments, some parts of the surface have different reflective characteristics. In some embodiments, the surface is randomly textured so that light is trapped in the microstructure. In some embodiments the surface is deterministically textured in the fabrication process to enhance light trapping.

This body 410 contains a plurality of features 411 and 412 that act as internal baffles to enhance the absorption of stray light rays. It further contains an internal aperture 413 and apertures 414 and 416 for mirrors 318 and 320, respectively. Such baffles and apertures dramatically reduce stray rays, providing for enhanced fluorescence detection sensitivity, however they may be cost prohibitive to produce using conventional machining, casting, or molding. The novel use of additive manufacturing to produce this body provides the design freedom to combine many conventionally challenging features into one or a few bodies economically.

FIGS. 4A and 4B show a combination condenser lens holder and stray-light reduction system 418 for the illuminator 302. In some embodiments, it may be produced using an additive process. In some embodiments the aperture 308 may be combined with this element.

FIGS. 4A and 4B also show a beam-splitter holder 420 that holds the beam splitter 312. In some embodiments, this beamsplitter holder 420 may be combined with body 410, condenser lens holder and stray-light reduction system 418, or the aperture 308.

Circuitry for driving the illuminator 302 may be formed on a printed circuit board 419. Having this driver board, the illuminator, and camera, three-heat generating elements of the microscope in intimate contact with the heat sink and exchanger 210 prevents excessive internal temperatures. In some embodiments, adhesive pads that enhance heat transfer are employed to make good thermal contact between heat generators and the heat sink. In some embodiments, thermally conductive greases may be used, provided these greases do not outgas or attack materials in the camera and that care is taken to avoid contamination of optical elements. In other embodiments, thermally conductive epoxies or mechanical pressure may be used to enhance heat transfer efficiency.

FIG. 4B shows a hatched section view 430 taken at the position of ray 301 looking toward mirror 318. This view shows the boundaries of the baffles 411. In this embodiment, the baffles are recessed considerably from the path of the rays. Recessing the baffles has the advantage of keeping light scattered from the edges of the baffles away from the field of view of the camera. The baffles should at least be recessed enough from the light path so that they do not limit spatial resolution or produce vignetting of the fluorescence image. The aperture 416 reveals enough of mirror 318 to pass the fluorescence light bundle and its diffractive lobes. The facets of 416 are oriented to reflect stray light onto the baffles. In some embodiments, the aperture itself contains a baffle substantially in the direction of the ray path. Whether an aperture having a faceted reflector oriented substantially normal to the incoming rays as in FIG. 4B or oriented substantially in the direction of the incoming rays performs better for eliminating stray beams depends on the surface properties of the baffle.

In some embodiments, additional cavities can be engineered into the solid-filled regions 432 to enhance trapping of stray light and to reduce the body fabrication times.

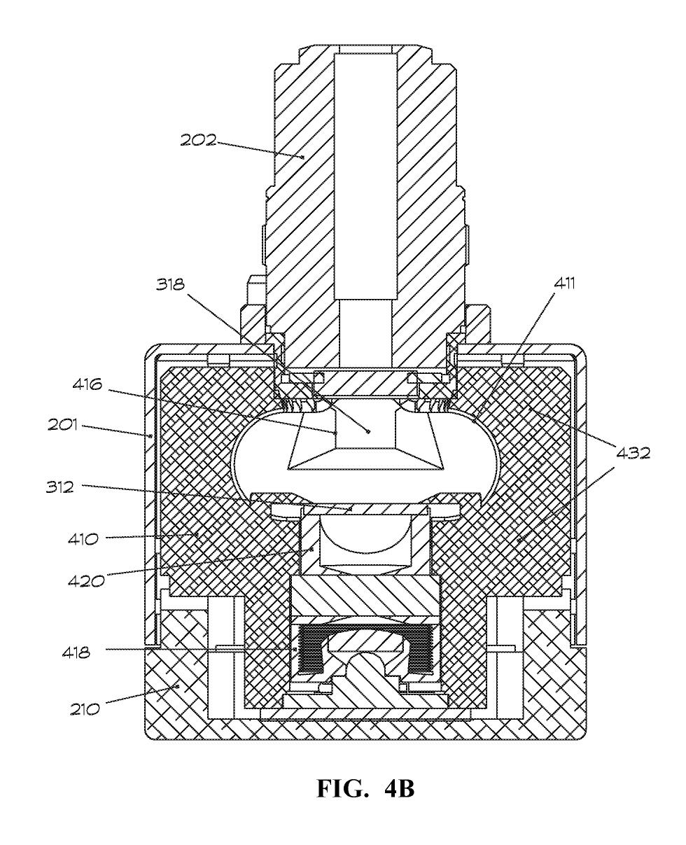

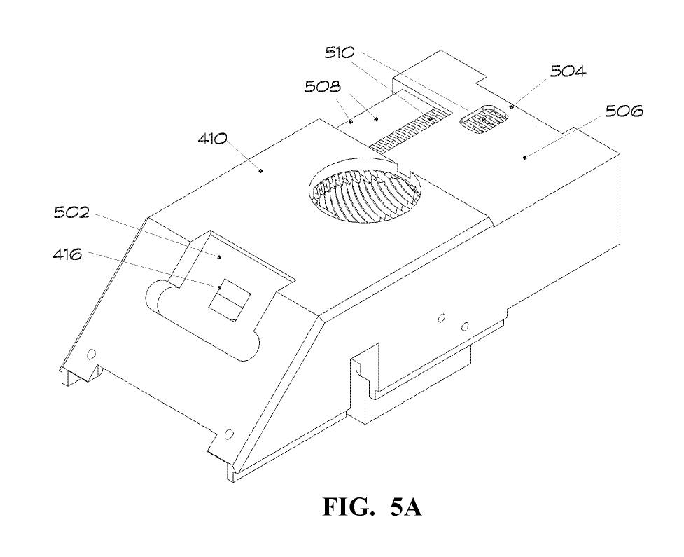

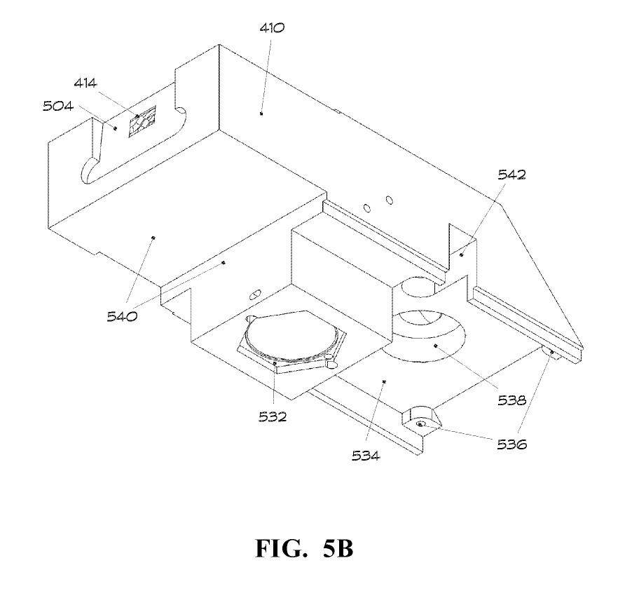

FIG. 5A shows a top isometric view of the body 410. The mirror 320 is mounted on a mounting surface 502. The mirror 318 is mounted on a mounting surface 504. The recessed surface 506 provides space for a printed circuit board. The recesses 508 provide room for electrical connections. The openings 510 provide for enhanced removal of extraneous material from the additive manufacturing process.

FIG. 5B shows a bottom isometric view of the body 410. A recess 532 is formed for mounting for the illuminator 302, condenser optics 304 and 306 and beam splitter 312. Mounts 536 mount the camera in a recess 534. The emission filter 322 is mounted at a mounting site 538 for emission filter 322. Drive electronics for the illuminator 302 is housed in a cavity 540. The cavity 542 provides for enhanced removal of extraneous material from the additive manufacturing process.

FIG. 5C shows a top isometric view 550 of a section of the body 410 split down the center, revealing the inner features. The internal aperture 413 and the surrounding baffles contain cants 552 to enhance light trapping, features that may be impossible to manufacture conventionally. Beamsplitter 312 is mounted in a seat 554. The stray rays from the illuminator 302 reflecting off the beam splitter 312 are incident upon a surface 556. Light scattered from this surface 556 is in the field of view of the camera and is eliminated only by the emission filter. For this reason, the surface 556 may receive special attention, such as a gloss-black cover, e.g., from a self-adhesive tape or a thin neutral density absorption filter. The light reflecting off this surface enters a trap 558 having a rear cavity 560.

FIG. 5D shows a bottom isometric view 570 of the top section of the body 410 split slightly above surface 556, revealing details of the light trap 558. In some alternative embodiments the trap cavity sidewalls 560 contain radially disposed baffles for enhanced light trapping. The port 562 enhances removal of extraneous material from the additive manufacturing process.

In some embodiments of the present invention, the body 410 is manufactured in pieces, e.g., split along the centerline similar to the view in FIG. 5C to facilitate cleaning, removal of extraneous material from the manufacturing process, and assembly of internal parts. Such an assembly may obviate ports such as 510 and 562. In some embodiments, a plurality of parts to be assembled into a microscope, e.g., 410 or components that assemble to comprise body 410, illuminator housing 418, beam-splitter holder 420 and aperture 308 or a subset of these parts are manufactured in their proper relative position with fine seams between the parts, assuring accurate registration of size. In some preferred embodiments, the seams are engineered to follow a path that prevents light from entering or escaping, for example with overlaps. In some embodiments, these overlapped seams contain detents or features for interlocking.

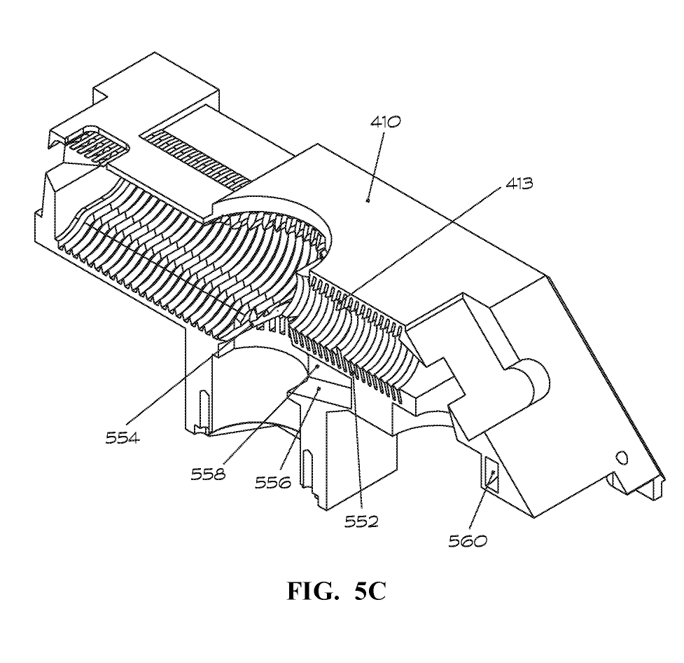

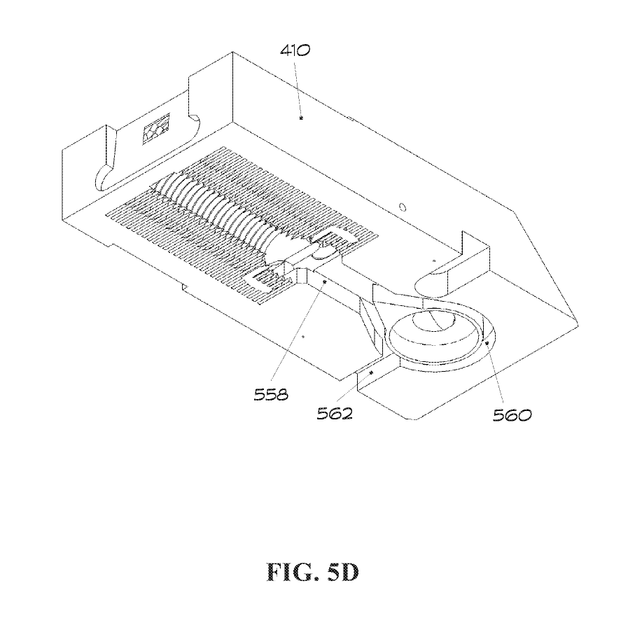

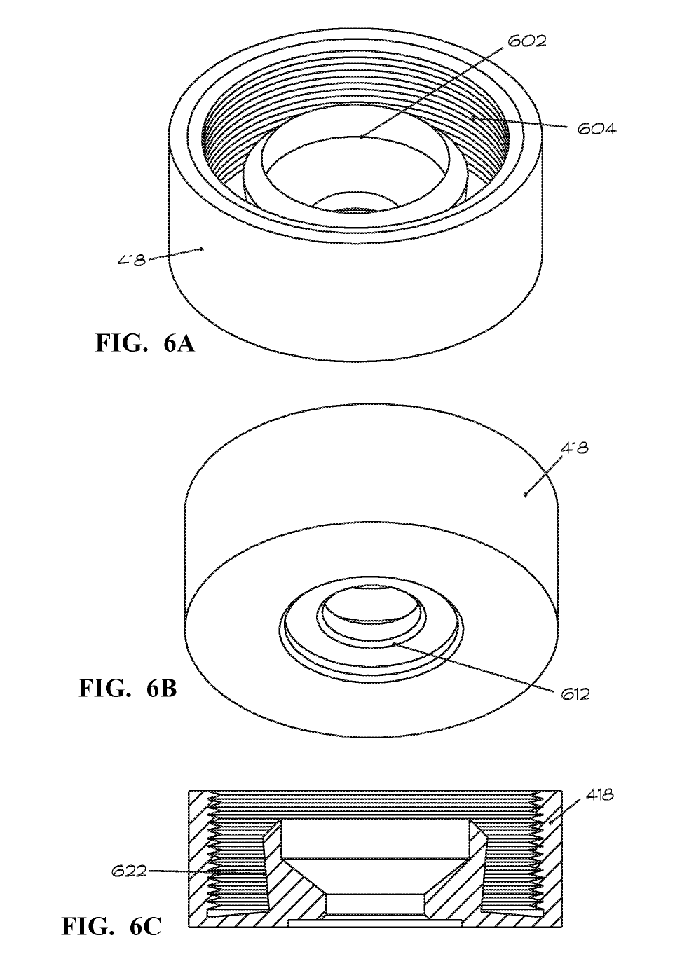

FIG. 6A shows a top isometric view of the illuminator housing 418. FIG. 6A shows a seat 602 is the seat for the condenser lens 306. Baffles 604 surround the seat 602. FIG. 6B shows a bottom isometric view of the illuminator housing. An indexing aperture 612 indexes with lens 304 to ensure proper relative alignment of lenses 306 and 304. FIG. 6C shows a cross sectional view of the illuminator housing. Note that using an additive process to make such a part frees the designer to employ negative draft angles 622 and other features that enhance light trapping but would otherwise tremendously complicate manufacturing.

Some embodiments of the present invention are employed as swappable modules in a system such as shown in FIGS. 1A and 1B. In such use, a user may swap one epilfluorescence microscope for another when a difference set of colors or fluorophores are probed rather than change components internal to the microscope as in conventional epifluorescence modules. This allows embodiments of the present invention to be manufactured without dust, contaminants, and smudges on the internal surfaces, especially internal optical surfaces and to remain free of these defects in spite of operation in unclean environments.

In some embodiments, the epifluorescence microscope modules may be swapped with power on. In some embodiments the epifluorescence microscope contains a device, such as a serial EEPROM or microcontroller, that can be queried and written about information including some of the following items: the hardware version, firmware version, illuminator wavelength, characteristic of filters and beam splitters, microscope objective, indexes that identify the types of filters, beam splitters, objectives, and illuminators contained within the microscope, and the like.

What is claimed is:

1. An epifluorescence microscope comprising an element made by an additive manufacturing process that houses part of the light path of the microscope.

2. The epifluorescence microscope of claim 1 further comprising a baffle in the element.

3. The epifluorescence microscope of claim 1 wherein the element has an aperture therein.

4. The epifluorescence microscope of claim 1 further comprising optic seats formed in the element for mounting optics components therein.

5. The epifluorescence microscope of claim 1 further comprising a cavity-based light trap in the element.

6. The epifluorescence microscope of claim 1 wherein the element includes a port for removing extraneous material from manufacturing the element.

7. An epifluorescence microscope comprising a fluorescence light source and a beamsplitter arranged such that fluorescence light from the fluorescence light source reflects off the first encountered surface of the beam-splitter.

8. An epifluorescence microscope that is sealed from dust, light, and liquids having internal filters and optics that are pre-assembled.

9. The epifluorescence microscope of claim 8 comprising a plurality of externally disposed contacts for electrical connections.

10. The epifluorescence microscope of claim 8, further comprising a wireless electrical link.

11. The epifluorescence microscope of claim 10, further comprising an inductively coupled power source.

12. The epifluorescence microscope of claim 11, further comprising all contactless electrical links.
